(19) United States
(12) Patent Application Publication
(10) Pub. No.: US 2003/0032720 A1
(43) Pub. Date: Feb. 13, 2003

(54) Aqueous dispersions for hydrolysis-resistant coatings

(75) Inventors: Karl Haeberle, Speyer (DE); Gundo Brauch, Hassloch (DE); Klaus Dieter Hoerner, Mannheim (DE); Juergen Reichert, Limburgerhof (DE); Hermann Seyffer, Heidelberg (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellschaft, Ludwigshafen (DE)

(21) Appl. No.: 10/192,166

(22) Filed: Jul. 11, 2002

(30) Foreign Application Priority Data
Jul. 16, 2001 (DE) 101 33 789.2

(51) Int. Cl. C08K 3/00

(52) U.S. Cl. 524/589

(57) ABSTRACT

Aqueous dispersions for hydrolysis-resistant coatings, comprising a polyurethane synthesized from

a) diisocyanates,

b) diols of which

b₁) from 10 to 100 mol %, based on the total amount of diols (b), have a molecular weight of from 500 to 5 000 g/mol and

b₂) from 0 to 90 mol %, based on the total amount of diols (b), have a molecular weight of from 60 to 500 g/mol,

c) monomers other than (a) and (b), containing at least one isocyanate group or at least one isocyanate-reactive group and further bearing at least one hydrophilic group or one potentially hydrophilic group whereby the polyurethane is made water dispersible,

d) if desired, further polyfunctional compounds, other than monomers (a) to (c), containing reactive groups which are alcoholic hydroxyl, primary or secondary amino, or isocyanate groups, and

e) if desired, monofunctional compounds, other than monomers (a) to (d), containing a reactive group which is an alcoholic hydroxyl, primary or secondary amino, or isocyanate group,

obtainable by reacting monomers a), b), c), and, where appropriate, d) and e) in the absence of organometallic catalysts at temperatures of from 100 to 180° C. for average reaction times of from 1 to 20 hours.

The present invention relates to aqueous dispersions for hydrolysis-resistant coatings, comprising a polyurethane synthesized from

a) diisocyanates,

b) diols of which

b₁) from 10 to 100 mol %, based on the total amount of diols (b), have a molecular weight of from 500 to 5 000 g/mol and

b₂) from 0 to 90 mol %, based on the total amount of diols (b), have a molecular weight of from 60 to 500 g/mol,

c) monomers other than (a) and (b), containing at least one isocyanate group or at least one isocyanate-reactive group and further bearing at least one hydrophilic group or one potentially hydrophilic group whereby the polyurethane is made water dispersible,

d) if desired, further polyfunctional compounds, other than monomers (a) to (c), containing reactive groups which are alcoholic hydroxyl, primary or secondary amino, or isocyanate groups, and

e) if desired, monofunctional compounds, other than monomers (a) to (d), containing a reactive group which is an alcoholic hydroxyl, primary or secondary amino, or isocyanate group,

obtainable by reacting monomers a), b), c), and, where appropriate, d) and e) in the absence of organometallic catalysts at temperatures of from 100 to 180° C. for average reaction times of from 1 to 20 hours.

The invention further relates to methods of coating, adhesively bonding, and impregnating articles of different materials using these dispersions, to the articles coated, adhesively bonded, and impregnated using these dispersions, and to the use of the dispersions of the invention as hydrolysis-resistant coating materials.

The use of aqueous dispersions comprising polyurethanes (PU dispersions for short) to coat substrates such as textile or leather has been known for a long time. Owing to their 2 outstanding mechanical properties, it is preferred to use polyesterol-based PU dispersions for this purpose.

Oftentimes, the substrates coated in this way are exposed to the influence of a warm, humid atmosphere. It is then found that the coatings lose their mechanical stability as a consequence of hydrolytic degradation.

From U.S. Pat. No. 4,113,676, it is known that aqueous PU dispersions may be protected against hydrolytic degradation by adding monocarbodiimides that bear no further functional groups. A disadvantage of these systems,-however, is the presence of the low molecular mass carbodiimides (CDI), which, for example, may migrate from the coating and so lead to hygiene problems. A further disadvantage is that the acylureas formed from reaction of the CDI with carboxyl groups split into amide and the carbodiimide's parent isocyanate (Williams & Ibrahim; Chem. Rev., 81, 603 (1981), which may likewise migrate and lead to problems.

WO 96/08 524, EP-A 207 414, and DE-A 4 039 193 disclose aqueous dispersions of polyisocyanate adducts containing acylurea. They are prepared by first preparing carbodiimide-containing polyurethanes or prepolymers and reacting the carbodiimide groups with carboxylic acids such as stearic acid to give the acylurea groups, before the polyurethanes are dispersed.

EP-B 595 149 discloses the use of aqueous PU dispersions to produce pore-free, water-vapor-permeable coatings. The PU dispersions used are prepared by reacting the corresponding monomers at temperatures of less than 100° C.

EP-A 1 002 001 relates to PU dispersions suitable as highly hydrolysis-resistant coatings for materials of metal, plastic, paper, textile, leather or wood. The PU dispersions it uses, however, must include carbodiimides, which have to be prepared beforehand, which is laborious, and which, moreover, are very expensive.

It is an object of the present invention to remedy the disadvantages described and to develop improved PU dispersions which also have a high level of hydrolysis resistance without the use of expensive carbodiimides.

We have found that this object is achieved by the aqueous dispersions defined at the outset and a process for their preparation. We have also developed a method of producing coatings, adhesive bonds, and impregnations. The present invention further extends to the articles thus coated, adhesively bonded, and impregnated and to their use as a hydrolysis-resistant coating.

The aqueous dispersions of the invention for hydrolysis-resistant coatings comprise polyurethanes which besides other monomers are derived from diisocyanates a) which are preferably those commonly used in polyurethane chemistry.

As monomers (a), mention is to be made in particular of diisocyanates X(NCO)₂, where X is an aliphatic hydrocarbon radical having from 4 to 12 carbon atoms, a cycloaliphatic or aromatic hydrocarbon radical having from 6 to 15 carbon atoms or an araliphatic hydrocarbon radical having from 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, cis/cis, and cis/trans isomer, and mixtures of these compounds.

Diisocyanates of this kind are available commercially.

Particularly important mixtures of these isocyanates are the mixtures of the respective structural isomers of diisocyanatotoluene and diisocyanatodiphenylmethane, a particularly suitable mixture being that of 80 mol % 2,4-diisocyanatotoluene and 20 mol % 2,6-diisocyanatotoluene. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, the preferred mixture ratio of aliphatic to aromatic isocyanates being from 4:1 to 1:4.

Compounds used in synthesizing the polyurethanes may include not only those mentioned above but also isocyanates which in addition to the free isocyanate groups bear further, blocked, isocyanate groups, e.g., uretdione groups.

For good film formation and elasticity, diols (b) which are suitable are especially high molecular mass diols (b₁), having a molecular weight of from about 500 to 5 000, preferably from about 1 000 to 3 000, g/mol.

The diols (b₁) are especially polyesterpolyols as known, for example, from Ullmanns Encyklopadie der technischen Chemie, 4th Edition, Volume 19, pp. 62-65, preferably those obtained by reacting dihydric alcohols with dibasic carboxylic acids. Instead of the free polycarboxylic acids, it is also possible to employ their anhydrides or esters with lower alcohols, or mixtures thereof, in order to prepare the polyesterpolyols. The polycarboxylic acids may be aliphatic, cycloaliphatic, araliphatic, aromatic or heterocyclic and may be unsaturated and/or substituted, by halogen atoms for example. Examples of such compounds are suberic, azelaic, phthalic and isophthalic acids, phthalic, tetrahydrophthalic, hexahydrophthalic, tetrachlorophthalic, endo-methylenetetrahydrophthalic and glutaric anhydrides, maleic acid, maleic anhydride, fumaric acid and dimeric fatty acids. Preferred dicarboxylic acids are those of the formula HOOC—(CH₂)_{y}—COOH in which y is 1-20, preferably an even number from 2 to 20, examples being succinic, adipic, sebacic and dodecanedicarboxylic acids.

Examples of polyhydric alcohols are ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene, triethylene, tetraethylene, polyethylene, dipropylene, polypropylene, dibutylene and polybutylene glycols. Preference is given to alcohols of the formula HO—(CH₂)ₓ—OH in which x is 1-20, preferably an even number from 2 to 20, examples thereof being ethylene glycol, butane-1,4-diol, hexane-1,6-diol, octane-1,8-diol and dodecane-1,12-diol. Neopentyl glycol is also preferred.

Also suitable are polycarbonatediols as can be obtained, for example, by reacting phosgene with an excess of the low molecular mass alcohols mentioned as synthesis components for the polyesterpolyols.

Suitability extends to lactone-based polyesterdiols, which are homo- or copolymers of lactones, preferably hydroxyl-terminated adducts of lactones with suitable difunctional starter molecules. Suitable lactones are preferably those derived from compounds of the formula HO—(CH₂)_{z}—COOH in which z is 1-20 and a hydrogen atom of a methylene unit may alo be substituted by a C₁-C₄ alkyl radical, examples being ε-caprolactone, β-propiolactone, γ-butyrolactone and/or methyl-ε-caprolactone and mixtures thereof. Examples of suitable starter components are the low molecular mass dihydric alcohols mentioned above as synthesis components for the polyesterpolyols. The corresponding polymers of ε-caprolactone are particularly preferred. Lower polyesterdiols or polyetherdiols can also be used as starters for preparing the lactone polymers. Instead of the polymers of lactones, it is also possible to employ the corresponding, chemically equivalent polycondensates of the hydroxycarboxylic acids corresponding to the lactones.

Further suitable monomers (b₁) are polyetherdiols. They are obtainable, in particular, by polymerizing ethylene oxide, propylene oxide, butylene oxide, tetrahydrofuran, styrene oxide or epichlorohydrin with itself, for example, in the presence of BF₃, or by subjecting these compounds, alone or in a mixture or in succession, to addition reactions with starting components containing reactive hydrogens, such as alcohols or amines, for example, water, ethylene glycol, propane-1,2-diol, propane-1,3-diol, 1,2-bis(4-hydroxydiphenyl)propane or aniline. Particular preference is given to polytetrahydrofuran with a molecular weight ranging of from 240 to 5 000 and especially from 500 to 4 500.

Likewise suitable are polyhydroxyolefins, preferably those having 2 terminal hydroxyls, for example α,ω)-dihydroxypolybutadiene, α,ω-dihydroxypolymethacrylic ester or α,ω-dihydroxypolyacrylic ester, as monomers (b₁). Such compounds are known, for example, from EP-A-0 622 378. Other suitable polyols are polyacetals, polysiloxanes and alkyd resins.

The polyols may also be employed as mixtures in a ratio of from 0.1:1 to 1:9.

The hardness and modulus of elasticity of the polyurethanes can be increased if the diols (b) employed include not only diols (b₁) but also low molecular mass diols (b₂) having a molecular weight of from about 60 to 500, preferably of from 62 to 200 g/mol.

The compounds used as monomers (b₂) are in particular the synthesis components of the short-chain alkanediols mentioned for the preparation of polyesterpolyols, with preference being given to the unbranched diols having from 2 to 12 carbon atoms and an even number of carbon atoms and to pentane-1,5-diol and neopentyl glycol.

Based on the total amount of diols (b), the proportion of diols (b₁) is preferably from 10 to 100 mol % and that of monomers (b₂) is preferably from 0 to 90 mol %. The ratio of the diols (b₁) to the monomers (b₂) is particularly preferably from 0.1:1 to 5:1, particularly preferably from 0.2:1 to 2:1.

To give the polyurethanes dispersibility in water, they are synthesized not only from components (a), (b), and, where appropriate, (d) but also from monomers (c) other than components (a), (b) and (d), which bear at least one isocyanate group or at least one isocyanate-reactive group and, in addition, at least one hydrophilic group or a group which can be converted into a hydrophilic group. In the text below, the term “hydrophilic groups or potentially hydrophilic groups” is abbreviated to “(potentially) hydrophilic groups”. The (potentially) hydrophilic groups react with isocyanates substantially more slowly than the functional groups of the monomers used to synthesize the polymer main chain.

The proportion of components having (potentially) hydrophilic groups among the total amount of components (a), (b), (c), (d) and (e) is generally such that the molar amount of (potentially) hydrophilic groups, based on the amount by weight of all monomers (a) to (e), is from 30 to 1 000 mmol/kg, preferably from 50 to 500 mmol/kg and, with particular preference, from 80 to 300 mmol/kg.

The (potentially) hydrophilic groups may be nonionic or, preferably, (potentially) ionic hydrophilic groups.

Suitable nonionic hydrophilic groups are, in particular, polyethylene glycol ethers comprising preferably from 5 to 100, preferably from 10 to 80, ethylene oxide repeating units. The content of polyethylene oxide units is generally from 0 to 10% by weight, preferably from 0 to 6% by weight, based on the amount by weight of all monomers (a) to (e).

Preferred monomers containing nonionic hydrophilic groups are polyethylene oxide mono- and diols and also the reaction products of a polyethylene glycol and a diisocyanate which carry a terminally etherified polyethylene glycol radical. Diisocyanates of this kind and methods of preparing them are indicated in patents U.S. Pat. No. 3,905,929 and U.S. Pat. No. 3,920,598.

Ionic hydrophilic groups are, in particular, anionic groups, such as the sulfonate, carboxylate and phosphate group, in the form of their alkali metal or ammonium salts, and also cationic groups, such as ammonium groups, especially protonated tertiary amino groups or quaternary ammonium groups.

Potentially ionic hydrophilic groups are, in particular, those which by simple neutralization, hydrolysis or quaternization reactions can be converted into the abovementioned ionic hydrophilic groups, examples therefore being carboxylic acid or tertiary amino groups.

(Potentially) ionic monomers (c) are described in detail, for example, in Ullmanns Encyklopadie der technischen Chemie, 4th Edition, Volume 19, pp. 311-313 and DE-A 1 495 745.

Of particular significance in practice as (potentially) cationic monomers (c) are especially monomers containing tertiary amino groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines and N-aminoalkyldialkylamines, in which the alkyl radicals and alkanediyl units of these tertiary amines have, independently of one another, from 1 to 6 carbons. Others which come into consideration are polyethers which have tertiary nitrogens and preferably two terminal hydroxyls, as can be obtained, for example, by alkoxylating amines which have two hydrogens attached to the amine nitrogen, e.g. methylamine, aniline or N,N′-dimethylhydrazine, in a manner known per se. Polyethers of this kind generally have a molar weight of from 500 to 6 000 g/mol.

These tertiary amines are converted into the ammonium salts either with acids, preferably strong mineral acids such as phosphoric, sulfuric or hydrohalic acids or strong organic acids, or by reaction with suitable quaternizing agents, such as C₁-C₆ alkyl halides or benzyl halides, for example bromides or chlorides.

Suitable monomers containing (potentially) anionic groups are, customarily, aliphatic, cycloaliphatic, araliphatic or aromatic carboxylic and sulfonic acids which carry at least one alcoholic hydroxyl group or at least one primary or secondary amino group. Preference is given to dihydroxyalkylcarboxylic acids, especially of 3 to 10 carbons, as are also disclosed in U.S. Pat. No. 3,412,054. Particular preference is given to compounds of the formula (c₁)

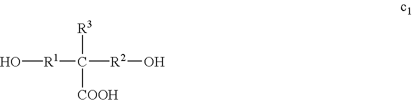

in which R¹ and R² is a C₁-C₄ alkanediyl unit, and R³ is a C₁-C₄ alkyl unit, and especially to dimethylolpropionic acid (DMPA).

Corresponding dihydroxysulfonic acids and dihydroxyphosphonic acids such as 2,3-dihydroxypropanephosphonic acid are also suitable.

Suitability extends to dihydroxy compounds having a molecular weight of from 500 to 10 000 g/mol and at least 2 carboxylate groups, which are known from DE-A 3 911 827. They can be obtained by reacting dihydroxy compounds with tetracarboxylic dianhydrides, such as pyromellitic dianhydride or cyclopentanetetracarboxylic dianhydride, in a molar ratio from 2:1 to 1.05:1 in a polyaddition reaction. Particularly suitable dihydroxy compounds are the monomers (b₂) mentioned as chain extenders and also the diols (b₁).

Suitable monomers (c) containing isocyanate-reactive amino groups are aminocarboxylic acids such as lysine, β-alanine, or the adducts of aliphatic diprimary diamines with α,β-unsaturated carboxylic or sulfonic acids mentioned in DE-A 2034479.

Such compounds conform, for example, to the formula (c₂)

H₂N—R⁴—NH—R⁵—X (c₂)

where

R⁴ and R⁵ independently of one another are a C₁-C₆ alkanediyl unit, preferably ethylene,

and X is COOH or SO₃H.

Particularly preferred compounds of the formula (c₂) are N-(2-aminoethyl)-2-aminoethanecarboxylic acid and N-(2-aminoethyl)-2-aminoethanesulfonic acid, and the corresponding alkali metal salts, with Na being a particularly preferred counterion.

Particular preference is also given to the adducts of the abovementioned aliphatic diprimary diamines with 2-acrylamido-2-methylpropanesulfonic acid, such as are disclosed, for example, in the DE patent 1 954 090.

Where monomers having potentially ionic groups are employed, they can be converted into the ionic form prior to, during but preferably after the isocyanate polyaddition, since the ionic monomers are frequently difficult to dissolve in the reaction mixture. With particular preference, the sulfonate or carboxylate groups are in the form of their salts with an alkali metal ion or ammonium ion as counterion.

The monomers (d), which are different from the monomers (a) to (c) and which are also, where appropriate, constituents of the polyurethane, serve generally for crosslinking or chain extension. In general, they are nonphenolic alcohols with a functionality of more than 2, amines with 2 or more primary and/or secondary amino groups, and compounds which bear not only one or more alcoholic hydroxyl groups but also one or more primary and/or secondary amino groups.

Alcohols with a functionality of more than 2 that can be used to establish a certain degree of branching or crosslinking are, for example, trimethylolpropane, glycerol and sucrose.

Others which come into consideration are monoalcohols which as well as the hydroxyl group bear a further isocyanate-reactive group, such as monoalcohols containing one or more primary and/or secondary amino groups; one example is monoethanolamine.

Polyamines with 2 or more primary and/or secondary amino groups are used in particular when chain extension or crosslinking is to take place in the presence of water, since amines generally react faster with isocyanates than do alcohols or water. This is frequently necessary when the desire is for aqueous dispersions of crosslinked polyurethanes or of polyurethanes of high molecular weight. In such cases, a procedure is followed in which isocyanato-containing prepolymers are prepared, are dispersed rapidly in water and are then chain-extended or crosslinked by adding compounds having two or more isocyanate-reactive amino groups.

Amines suitable for this purpose are generally polyfunctional amines from the molecular weight range of from 32 to 500 g/mol, preferably of from 60 to 300 g/mol, and contain at least two amino groups selected from the group consisting of primary and secondary amino groups. Examples thereof are diamines, such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine or hydrazine hydrate, or triamines, such as diethylenetriamine or 1,8-diamino-4-aminomethyloctane.

The amines may also be employed in blocked form, for example in the form of the corresponding ketimines (see, e.g., CA-A 1 129 128), ketazines (cf., e.g., U.S. Pat. No. 4,269,748) or amine salts (see U.S. Pat. No. 4,292,226). In addition, oxazolidines as used, for example, in U.S. Pat. No. 4,192,937 constitute blocked polyamines, which for preparing the polyurethanes of the invention may be used for chain extending the prepolymers. When such blocked polyamines are used, they are generally mixed with the prepolymers in the absence of water to form a mixture which is subsequently combined with the dispersion water or with part of the dispersion water, such that the corresponding polyamines are released by hydrolysis.

It is preferred to use mixtures of diamines and triamines, with particular preference mixtures of isophoronediamine (IPDA) and diethylenetriamine (DETA).

The polyurethanes contain preferably from 1 to 30, with particular preference from 4 to 25 mol %, based on the total amount of components (b) and (d), of a polyamine containing at least 2 isocyanate-reactive amino groups as monomers (d).

Alcohols with a functionality of more than 2 that can be used to establish a certain degree of branching or crosslinking are, for example, trimethylolpropane, glycerol or sucrose.

For the same purpose, it is also possible, as monomers (d), to use isocyanates with a functionality of more than two. Examples of commercial compounds are the isocyanurate or the biuret of hexamethylene diisocyanate.

Monomers (e), which may be used if desired, are monoisocyanates, monoalcohols, and mono-primary and -secondary amines. In general, their proportion is not more than 10 mol %, based on the total molar amount of the monomers. These monofunctional compounds normally bear further functional groups such as olefinic groups or carbonyl groups, and serve to introduce functional groups into the polyurethane that allow the dispersal or crosslinking or further polymer-analogous reaction of the polyurethane. Monomers suitable for this purpose are those such as isopropenyl-α,α-dimethylbenzyl isocyanate (TMI) and esters of acrylic or methacrylic acid, such as hydroxyethyl acrylate or hydroxyethyl methacrylate.

Coatings having a particularly good profile of properties are obtained especially when substantially only aliphatic diisocyanates, the proportion of HMDI in particular being at least 33 mol %, cycloaliphatic diisocyanates or TMXDI are used as monomers (a), and when substantially only one polyesterdiol, synthesized from the aforementioned aliphatic diols and diacids, is used as monomer (b₁).

This monomer combination is outstandingly supplemented as component (c) by alkali metal salts of diaminosulfonic acids; with very particular preference by N-(2-aminoethyl)-2-aminoethanesulfonic acid and/or its corresponding alkali metal salts, the Na salt being the most highly suited, and a mixture of DETA/IPDA as component (d).

In the field of polyurethane chemistry, it is generally known how the molecular weight of the polyurethanes can be adjusted by choosing the proportions of mutually reactive monomers and the arithmetic mean of the number of reactive functional groups per molecule.

Normally, components (a) to (e) and their respective molar amounts are chosen such that the ratio A:B between

A) the molar amount of isocyanate groups and

B) the sum of the molar amounts of hydroxyl and of functional groups able to react with isocyanates in an addition reaction

is from 0.5:1 to 2:1, preferably from 0.8:1 to 1.5:1, particularly preferably from 0.9:1 to 1.2:1 and, with very particular preference, as close as possible to 1:1.

The monomers (a) to (e) that are used normally carry on average from 1.5 to 2.5, preferably from 1.9 to 2.1, and with particular preference 2.0 isocyanate groups and/or functional groups which are able to react with isocyanates in an addition reaction.

The polyurethanes present in the dispersion of the invention preferably contain no effective amounts of acylurea groups.

The polyaddition of components (a) to (e) for preparing the polyurethane present in the aqueous dispersions of the invention takes place at reaction temperatures of from 100 to 180° C., preferably of from 100 to 150° C., under atmospheric or autogenous pressure.

The reaction times required are in the range of from 1 to 20 hours, in particular in the range of from 1.5 to 10 hours. It is known in the field of polyurethane chemistry how the reaction time is influenced by a variety of parameters such as temperature, monomer concentration, and monomer reactivity.

The polyaddition of monomers a) to e) for preparing the PU dispersion takes place as well in the absence of organometallic catalysts. The term organometallic catalysts is intended to refer to compounds of elements from the following groups of the periodic table: Ia (except for hydrogen), IIa, IIIa with the exception of boron, IVa with the exception of carbon, Va with the exception of nitrogen and phosphorus, VIa with the exception of oxygen and sulfur, IIIb, IVb, Vb, VIb, VIIb, VIIIb, Ib, IIb, and the lanthanides and actinides, which contain an element-carbon covalent bond. They also include, inter alia, the frequently used organic tin compounds, such as dibutyltin dilaurate, for example.

Suitable polymerization apparatuses comprise stirred tanks, especially if solvents are used to provide a low viscosity and effective heat dissipation.

Preferred solvents are fully miscible with water, have a boiling point under atmospheric pressure of from 40 to 100° C., and react only slowly or not at all with the monomers.

The dispersions are usually prepared by one of the following methods:

In accordance with the acetone method, an ionic polyurethane is prepared from components (a) to (c) in a water-miscible solvent which boils below 100° C. at atmospheric pressure. A sufficient amount of water is added until a dispersion is formed in which water is the continuous phase.

The prepolymer mixing method differs from the acetone method in that the initial product prepared is not a fully reacted (potentially) ionic polyurethane but a prepolymer which carries isocyanate groups. In this case, the components are chosen so that the abovedefined ratio A:B is from more than 1.0 to 3, preferably from 1.05 to 1.5. The prepolymer is first dispersed in water and then, where appropriate, crosslinked by reacting the isocyanate groups with amines having more than 2 isocyanate-reactive amino groups or chain-extended using amines having 2 isocyanate-reactive amino groups. Chain extension also takes place if no amine is added. In this case, isocyanate groups are hydrolyzed to amino groups which react, extending the chain, with remaining isocyanate groups of the prepolymers.

Where a solvent was used in preparing the polyurethane, the majority of the solvent is usually removed from the dispersion by, for example, carrying out distillation under reduced pressure. The dispersions preferably have a solvent content of less than 10% by weight, and with particular preference are free from solvents.

The dispersions generally have a solids content of from 10 to 75% by weight, preferably of from 20 to 65% by weight, and a viscosity of from 10 to 500 mPas (measured at 20° C. at a shear rate of 250 s⁻¹).

Hydrophobic auxiliaries, which may be difficult to disperse homogeneously in the finished dispersion, such as, for example, phenol condensation resins of aldehydes and phenol and/or phenol derivatives, or epoxy resins and other polymers mentioned, for example, in DE-A 3903538, 43 09 079 and 40 24 567, which are used in polyurethane dispersions as adhesion promoters, for example, can be added to the polyurethane or to the prepolymer even before dispersion in accordance with the methods described in the two abovementioned documents.

The polyurethane dispersions may comprise commercially customary auxiliaries and additives such as blowing agents, defoamers, emulsifiers, thickeners and thixotropic agents, and colorants such as dyes and pigments.

The dispersions of the invention are suitable for coating articles of metal, plastic, paper, textile, leather or wood by applying them in the form of a film to said articles by conventional methods, i.e., by spraying or knife coating, for example, and drying the dispersion.

The dispersions are especially suitable for coating articles of plastic, paper, textile or leather by using known methods to beat the dispersion to a foam beforehand and then coating said articles with said foam.

The aqueous dispersions are particularly suitable for producing formulations as disclosed in DE-A 19 605 311. According to the teaching of DE-A 19 605 311, these formulations are used to coat woven or nonwoven textiles. As-a result of this treatment, these materials become flame retardant, watertight, and permeable to water vapor.

To product the coated woven or nonwoven textiles, the aqueous dispersions of the invention are applied to the textile substrate materials by customary methods, by knife coating or brushing, for example, and the coated substrate material is then dried.

A preferred procedure is as follows:

The aqueous dispersion is applied in foam form to the substrate material, since this greatly enhances the vapor permeability. For this, following the addition of the foam stabilizer and, where appropriate, of thickener and further additives such as flame retardants, the dispersion is foamed mechanically. This can be done in a foam mixer under high shearing force. A further possibility is to carry out foaming in a foam generator, by blowing in compressed air. Foaming is preferably carried out using a foam generator.

The foamed coating composition is then applied to the substrate material using customary coating equipment, such as a knife coater or other foam applicators. Application may be made to one or both sides, preferably to one side. The application rate per side is from 20 to 150 g/m², in particular from 50 to 90 g/m².

At rates below 20 g/m², good vapor permeability is obtained for a low cost, but the watertightness is poor. At rates above 150 g/m², cracks occur during drying.

Articles of metal, plastic, paper, leather or wood may likewise be adhesively bonded to other articles, preferably the aforementioned articles, by applying the aqueous dispersion of the invention in the form of a film to one such article and joining it to another article, before or after the drying of the film.

Articles of textile, leather or paper may be impregnated with the dispersions of the invention by soaking said articles with the aqueous dispersion and then drying them.

The aqueous dispersions of the invention are notable, among other qualities, for a high level of hydrolysis resistance, and can be very easily and inexpensively prepared, since for their preparation there is no need to use expensive carbodiimides. The dispersions of the invention are especially suitable for coating textiles or leather.

Experimental Section:

### EXAMPLE

400.0 g (0.20 mol) of a polyesterdiol synthesized from adipic acid, neopentyl glycol and 1,6-hexanediol, with an OH number of 56, 30.0 g (0.0084 mol) of a polyethylene oxide produced starting from butanol, with an OH number of 15, and 30 g of acetone were charged to a stirred flask and brought to 70° C. 129.0 g (0.4917 mol) of HMDI and 110.0 g (0.4948 mol) of IPDI were added thereto and the mixture was stirred at 110° C. for 60 minutes. Then 54.0 g (0.60 mol) of 1,4-butanediol were added and stirring was continued at 110° C. for 180 minutes. Thereafter the mixture was diluted with 710 g of acetone and cooled to 50° C. and its NCO content was determined as being 1.03% by weight (calculated: 1.02% by weight). 10 minutes after the addition of 25.3 g of a 50% strength aqueous solution of the sodium salt of 2-aminoethyl-2-aminoethanesulfonic acid, the product was dispersed with 870 g of water and then chain extended using 6.5 g of DETA and 2.4 g of IPDA in 100 g of water. Distillation of the acetone gave a fine dispersion having a solids content of approximately 40%.

### Comparative Example

400.0 g (0.20 mol) of a polyesterdiol synthesized from adipic acid, neopentyl glycol and 1,6-hexanediol, with an OH number of 56, 30.0 g (0.0084 mol) of a polyethylene oxide produced starting from butanol, with an OH number of 15, 0.15 g of DBTL and 30 g of acetone were charged to a stirred flask and brought to 70° C. 129.0 g (0.4917 mol) of HMDI and 110.0 g (0.4948 mol) of IPDI were added thereto and the mixture was stirred at 70° C. for 60 minutes. Then 54.0 g (0.60 mol) of 1,4-butanediol were added and stirring was continued at 70° C. for 120 minutes. Thereafter the mixture was diluted with 710 g of acetone and cooled to 50° C. and its NCO content was determined as being 1.02% by weight (calculated: 1.02% by weight). 10 minutes after the addition of 25.3 g of a 50% strength aqueous solution of the sodium salt of 2-aminoethyl-2-aminoethanesulfonic acid, the product was dispersed with 870 g of water and then chain extended using 6.5 g of DETA and 2.4 g of IPDA in 100 g of water. Distillation of the acetone gave a fine dispersion having a solids content of approximately 40%.

Abbreviations:

| | |
|---|---|
| DBTL | dibutyltin dilaurate |
| HMDI | di(isocyanatocyclohexyl)methane |
| IPDI | isophorone diisocyanate (1-isocyanato-3,5,5-trimethyl- |
| | 5-isocyanatomethylcyclohexane) |
| DETA | diethylenetriamine |
| IPDA | isophoronediamine |

For testing, films with a thickness of approximately 0.6 mm (dry) were cast from the dispersions and left to dry at 23° C. for three days. Immediately after their preparation and after a seven-day storage period at 70° C. and 90% relative humidity, their tensile strength was measured in accordance with DIN 53 504.

The test results are given in table 1.

| | Tensile strength [N/mm²] | | |
|---|---|---|---|
| | | 7d, 70° C., | |
| | immediate | 90% RH | Change [%] |
| Example | 29.1 | 22.4 | −23 |
| Comparative | 32.3 | 19.7 | −39 |
| example | | | |

From table 1 it is evident that the aqueous dispersions of the invention are notable, inter alia, for a high level of hydrolysis resistance which persists even after 7 days at 70° C. and 90% relative humidity (RH).

1. An aqueous dispersion for hydrolysis-resistant coatings, comprising a polyurethane synthesized from
a) diisocyanates,
b) diols of which
b₁) from 10 to 100 mol %, based on the total amount of diols (b), have a molecular weight of from 500 to 5 000 g/mol and
b₂) from 0 to 90 mol %, based on the total amount of diols (b), have a molecular weight of from 60 to 500 g/mol,
c) monomers other than (a) and (b), containing at least one isocyanate group or at least one isocyanate-reactive group and further bearing at least one hydrophilic group or one potentially hydrophilic group whereby the polyurethane is made water dispersible,
d) if desired, further polyfunctional compounds, other than monomers (a) to (c), containing reactive groups which are alcoholic hydroxyl, primary or secondary amino, or isocyanate groups, and
e) if desired, monofunctional compounds, other than monomers (a) to (d), containing a reactive group which is an alcoholic hydroxyl, primary or secondary amino, or isocyanate group,
obtainable by reacting monomers a), b), c), and, where appropriate, d) and e) in the absence of organometallic catalysts at temperatures of from 100 to 180° C. for average reaction times of from 1 to 20 hours:

2. An aqueous dispersion as claimed in claim 1, wherein 1-isocyanato-3,5,5-trimethyl-5-isocyanatomethylcyclohexane (IPDI), tetramethylxylylene diisocyanate (TMXDI) and bis(4-isocyanatocyclohexyl)methane (HMDI) are used as diisocyanates (a).

3. An aqueous dispersion as claimed in claim 1 or 2, wherein the diols (b₁) are polyesterdiols.

4. An aqueous dispersion as claimed in any of claims 1 to 3, wherein unbranched diols having from 2 to 12 carbon atoms are used as diols (b₂).

5. An aqueous dispersion as claimed in any of claims 1 to 4, wherein 2-aminoethyl-2-aminoethanesulfonic acid and its corresponding alkali metal salts are used as monomers (c).

6. An aqueous dispersion as claimed in any of claims 1 to 5, wherein the reaction of monomers a), b), c), and, where appropriate, d) and e) takes place at temperatures of from 100 to 150° C. for average reaction times of from 1.5 to 10 hours.

7. A process for preparing an aqueous dispersion for hydrolysis-resistant coatings, comprising a polyurethane synthesized from
a) diisocyanates,
b) diols of which
b₁) from 10 to 100 mol %, based on the total amount of diols (b), have a molecular weight of from 500 to 5 000 g/mol and
b₂) from 0 to 90 mol %, based on the total amount of diols (b), have a molecular weight of from 60 to 500 g/mol,
c) monomers other than (a) and (b), containing at least one isocyanate group or at least one isocyanate-reactive group and further bearing at least one hydrophilic group or one potentially hydrophilic group whereby the polyurethane is made water dispersible,
d) if desired, further polyfunctional compounds, other than monomers (a) to (c), containing reactive groups which are alcoholic hydroxyl, primary or secondary amino, or isocyanate groups, and
e) if desired, monofunctional compounds, other than monomers (a) to (d), containing a reactive group which is an alcoholic hydroxyl, primary or secondary amino, or isocyanate group,
which comprises reacting monomers a), b), c), and, where appropriate, d) and e) in the absence of organometallic catalysts at temperatures of from 100 to 180° C. for average reaction times of from 1 to 20 hours.

8. A method of coating an article of metal, plastic, paper, textile, leather or wood, which comprises applying thereto in the form of a film, and drying, an aqueous dispersion as claimed in any of claims 1 to 6.

9. A method as claimed in claim 8, wherein an aqueous dispersion as claimed in any of claims 1 to 6 is first beaten to a foam and then applied in the form of said beaten foam to the article.

10. A method of adhesively bonding an article of metal, plastic, paper, textile, leather or wood, which comprises applying an aqueous dispersion as claimed in any of claims 1 to 6 in the form of a film to one such article and joining said article to another article, before or after the drying of the film.

11. A method of impregnating an article of textile, leather or paper, which comprises soaking said article with the aqueous dispersion as claimed in any of claims 1 to 6 and then drying it.

12. An article coated, adhesively bonded or impregnated with the aqueous dispersion as claimed in any of claims 1 to 6.

13. The use of the aqueous dispersion as claimed in any of claims 1 to 6 as a hydrolysis-resistant coating for an article of metal, plastic, paper, textile, leather or wood.
